(19) United States
(12) Patent Application Publication
(10) Pub. No.: US 2024/0100527 A1
(43) Pub. Date: Mar. 28, 2024

(54) Histological Containment System with Support Shelf

(71) Applicant: Parhelia Biosciences Corporation, Austin, TX (US)

(72) Inventor: Nikolay SAMUSIK, Talent, OR (US)

(73) Assignee: Parhelia Biosciences Corporation, Austin, TX (US)

(21) Appl. No.: 18/468,866

(22) Filed: Sep. 18, 2023

Related U.S. Application Data
(60) Provisional application No. 63/376,199, filed on Sep. 19, 2022.

(51) Int. Cl. B01L 3/00

(52) U.S. Cl. CPC B01L 3/5085; B01L 2300/0609

(57) ABSTRACT

The present disclosure provides a support shelf for a histological container for use with multiple histological samples. The container can include shelf supports on interior sides of the container and orient the shelf at a downward angle for fluid flow. The shelf can support a plurality of sample slides across a support surface. The shelf can include an end support to maintain the slide on the support surface. To control fluid flow across the slide, the end support can encourage wicking to a wicking end support of the shelf in a controlled manner to maximize exposure of the specimen to the reagent and other fluids and reduce costs and expense of processing. Side rails at the side of the shelf help maintain slides on the shelf, and guide rails disposed inwardly from the side rails help maintain separation of the multiple slides placed on the shelf support surface.

### CROSS REFERENCE TO RELATED APPLICATIONS

This application claims the benefit of U.S. Provisional Application Ser. No. 63/376,199, entitled “Histological Containment System with Support Shelf”, filed Sep. 19, 2022, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to histological apparatuses and methods. More specifically, the disclosure relates to histological apparatuses, components, and methods of use for processing histological samples, including staining tissues with reagents.

### Description of the Related Art

Histology refers to the microscopic structure of the tissues of living organisms. To study such structure, histological samples, such as tissues, are often excised from an organism, and examined with microscopes. To assist in the examination, reagents can be used to selectively react chemically with different structures in the histological sample to form a contrast between histological features, such as cells compared to surrounding cells. Multiple selected reagents for multiple cells can form a type of mosaic under the microscope to enable more accurate identification through the contrasts that are created.

Traditionally, histological treatment has been manually performed. The placement of the reagent, spread across the surface of the sample by the reagent, time for the reagent to react and timing of rinsing, and other variables in the preparation of the sample affect the quality and success of a suitable sample for examination. Thus, automatic systems and in some cases including robotic systems have been seen as a solution to control repetitive procedures for the sample preparation. Such systems can also be used for managing multiple samples in small spaces. Such automation has led to standards on sizes of platforms and other features to promote interchangeability between manufacturers. However, within those standards, variations in design and methods occur. As one example, the containers holding the histological samples are typically an open top container to allow the robotic access to the sample. The samples can be supported on structures to allow reagents and other fluids to be placed on the sample. The fluids may not flow across the samples uniformly to allow consistent exposure to the fluids, resulting in a compromised sample preparation.

Thus, there remains a need for improvements in histological systems and components for the preparation of histological samples, particularly those systems designed for automatic processing with robotic handling systems.

### BRIEF SUMMARY OF THE INVENTION

The present disclosure provides a support shelf for a histological container for use with multiple histological samples. The container can include shelf supports that are coupled to the interior sides of the container and preferably orient the shelf at a downward angle for fluid flow over the shelf. The body of the shelf can support a plurality of sample slides across a support surface. The shelf can include an end support to maintain the slide on the support surface at an angular placement. To control the fluid flow across the slide, the end support can encourage wicking to a wicking end support of the shelf in a controlled manner to maximize exposure of the specimen to the reagent and other fluids and reduce costs and expense of processing. Side rails at the side of the shelf help maintain slides on the shelf, and guide rails disposed inwardly from the side rails help maintain separation of the multiple slides placed on the shelf support surface.

The disclosure provides a histological containment system having a container for preparing histological samples, comprising: a shelf configured to fit the container, comprising: a support body having a support surface configured to support a histological sample; and a wicking end support coupled to the support body. The wicking end support comprises a longitudinal extension that extends longitudinally from an end of the support surface; and an upright extension coupled to the longitudinal extension that extends transverse at a nonzero angle to a plane of the support surface; wherein the longitudinal extension is coupled to the support body with the wicking end support offset by a non-zero offset distance from the plane of the support surface vertically; and wherein the upright extension is coupled to the longitudinal extension by non-zero longitudinal distance from an end of the support body to a proximal surface of the upright extension.

### BRIEF DESCRIPTION OF THE SEVERAL VIEWS OF THE DRAWINGS

FIG. 1 is a schematic perspective view of an example of a histological containment system having a container with shelves for preparing histological samples.

FIG. 2 is a schematic perspective top right-hand view of a shelf to support slides having histological samples.

FIG. 3 is a schematic front view of the shelf with illustrative slides placed on a support surface of the slide and longitudinally supported by an embodiment of a wicking end support.

FIG. 4 is a schematic side view of the shelf.

FIG. 5 is a schematic top view of the shelf.

FIG. 6 is a schematic bottom view of the shelf.

FIG. 7 is a schematic perspective bottom left-hand view of the shelf

FIG. 8 is a schematic perspective detail view of the wicking end support coupled to the support body.

FIG. 9 is a schematic inclined side view of the shelf with an illustrative slide placed on the support surface and supported on an end with the wicking end support.

FIG. 10 is a schematic top view aligned with the plane of the shelf support surface of a cover pad supported on the shelf with a slide supported by the shelf under the cover pad.

FIG. 11 is a schematic top right hand perspective view of the cover pad supported on the shelf with a slide supported by the shelf under the cover pad.

FIG. 12 is a schematic front view of another embodiment of a shelf according to the invention.

FIG. 13 is a schematic front view of another embodiment of a shelf according to the invention.

FIG. 14 is a schematic detail view of a portion of a shelf.

FIG. 15 is a schematic perspective top left-hand view of another embodiment of a shelf according to the invention to support histological samples.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein.

The present disclosure provides a support shelf for a histological container for use with multiple histological samples. The container can include shelf supports that are coupled to the interior sides of the container and preferably orient the shelf at a downward angle for fluid flow over the shelf. The body of the shelf can support a plurality of sample slides across a support surface. The shelf can include an end support to maintain the slide on the support surface at an angular placement. To control the fluid flow across the slide, the end support can encourage wicking to a wicking end support of the shelf in a controlled manner to maximize exposure of the specimen to the reagent and other fluids and reduce costs and expense of processing. Side rails at the side of the shelf help maintain slides on the shelf, and guide rails disposed inwardly from the side rails help maintain separation of the multiple slides placed on the shelf support surface.

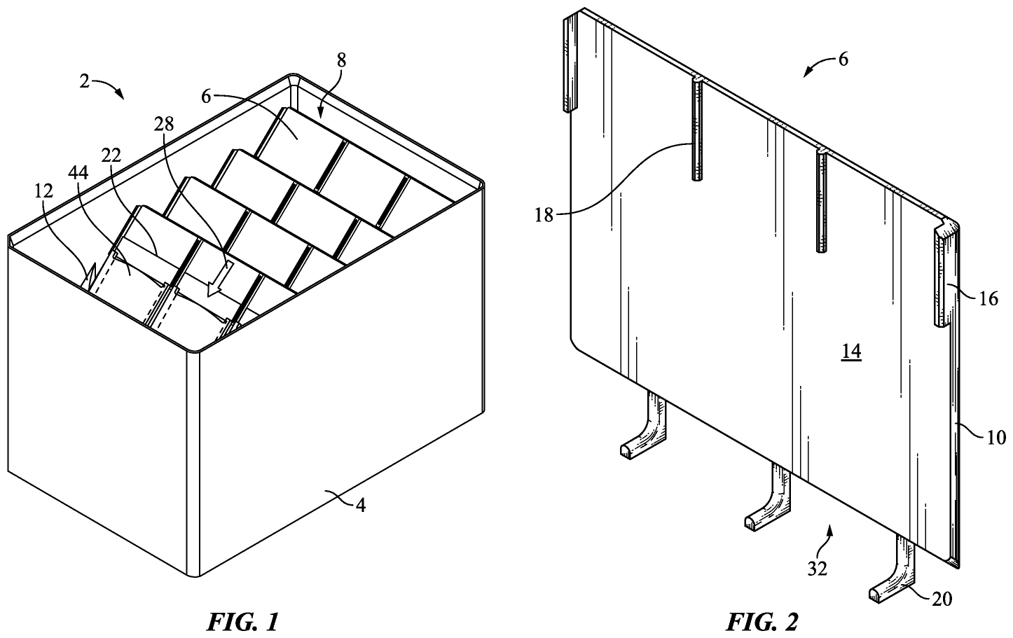

FIG. 1 is a schematic perspective view of an example of a histological containment system having a container with shelves for preparing histological samples. The system 2 includes a container 4 generally having an open top 8 for ready access to components and histological samples in the container at various stages of processing the samples. One or more shelves 6 can be placed in the container and supported by container supports 12 for the shelves. In at least one embodiment, the shelves can extend across the inside width (or length) of the container and the container walls can be formed with the container supports for the sides of the shelves to fit therebetween. The shelves 6 can support slides 22 generally having a histological sample placed thereon with cover pads 44 placed at least partially over the slides with a space between an underside of the cover pad and the face of the slide for fluid to flow therebetween. Alternatively, the shelves can support a support tile with a cover slip, known to those in the art, in like fashion. In at least one embodiment, the shelves 6 are generally tilted downward at an angle to use gravity to move reagents and other chemicals from the top of the shelf to the bottom of the shelf over the histological sample disposed on the slide and under the cover pad for processing the sample. An illustrative process is adding one or more reagent chemicals to the slide that stains the sample to amplify structures and substances for optical recognition typically under a microscope.

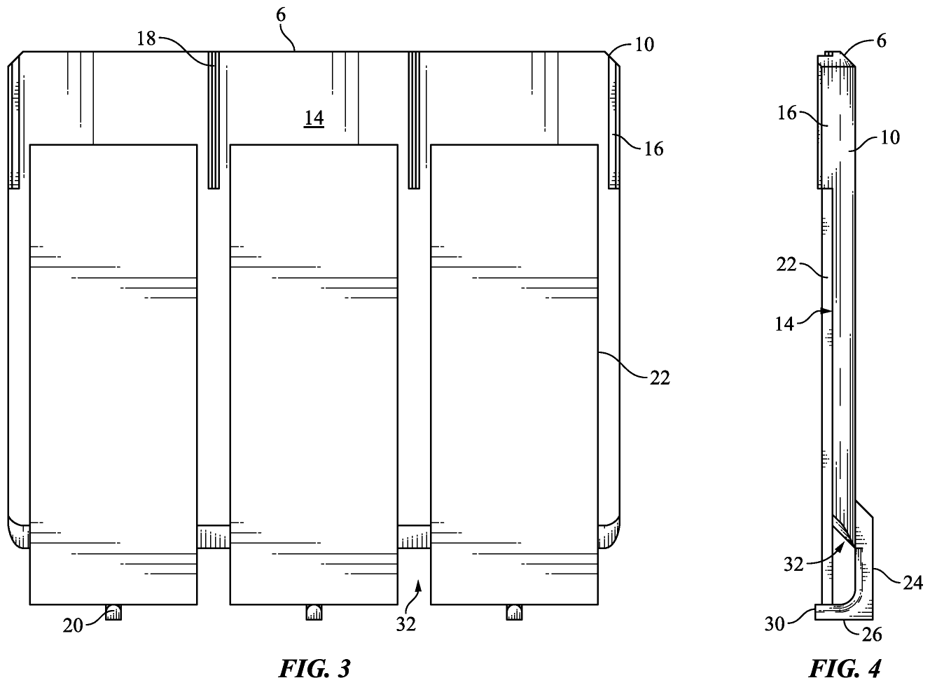

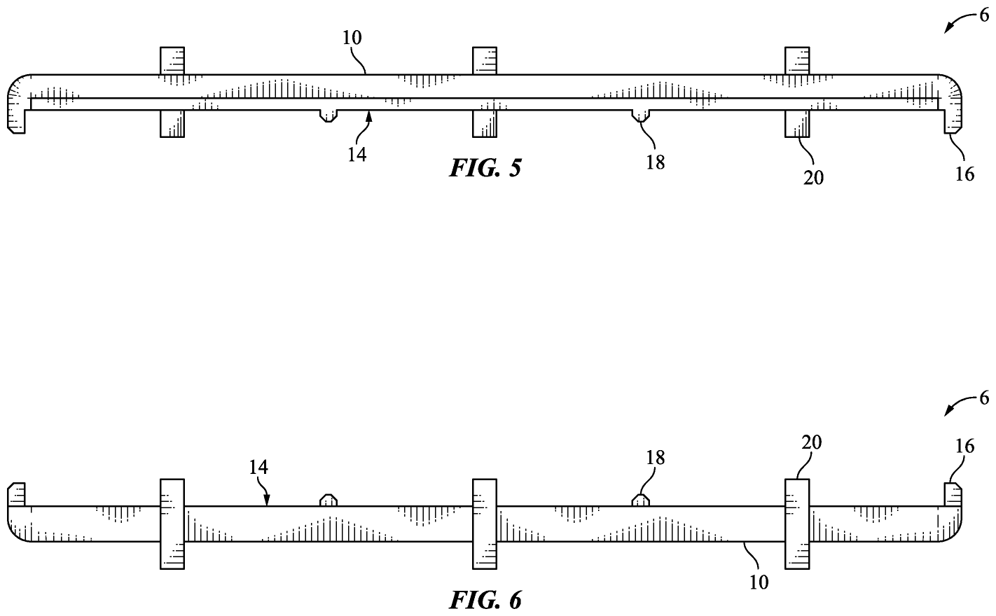

FIG. 2 is a schematic perspective top right-hand view of the shelf to support slides having histological samples. FIG. 3 is a schematic front view of the shelf with illustrative slides placed on a support surface of the slide and longitudinally supported by an embodiment of a wicking end support. FIG. 4 is a schematic side view of the shelf. FIG. 5 is a schematic top view of the shelf. FIG. 6 is a schematic bottom view of the shelf. The shelf 6 includes a shelf body 10 having a support surface 14 as the primary support for illustrative slides 22, shown in FIG. 1. In the illustrated embodiment, three spaces for slides are provided, but the number of spaces depending the design can vary from one to many. To provide stability, a side rail 16 on each side of the shelf body 10 can provide stability to maintain the slide(s) 22 on the support surface 14. To assist in maintaining separation between multiple slides, one or more guide rails 18 can be located as appropriate on the shelf body. Wicking end supports 20 can be coupled to a bottom end 32 of the shelf to restrain the downward movement of the slides 22 supported on the surface 14. As shown in FIG. 4, the wicking end support is not engaged longitudinally along the length of a longitudinal extension 24 with the slide 22 that is supported by the surface 14. The longitudinal extension 24 extends longitudinally downward from the bottom end 32 of the shelf body 10. An upright extension 26 of the wicking end support 20 is joined with the longitudinal extension and is disposed at a non-zero traverse angle to the support surface 14. The upright extension 26 restrains longitudinal movement of the slide 22 (and cover tile 44, if present) upon contact with the wicking end support. An end 30 of the upright extension extends upward past a plane of the support surface 14 to restrain slide (and cover tile) movement further downward on a sloping shelf 6.

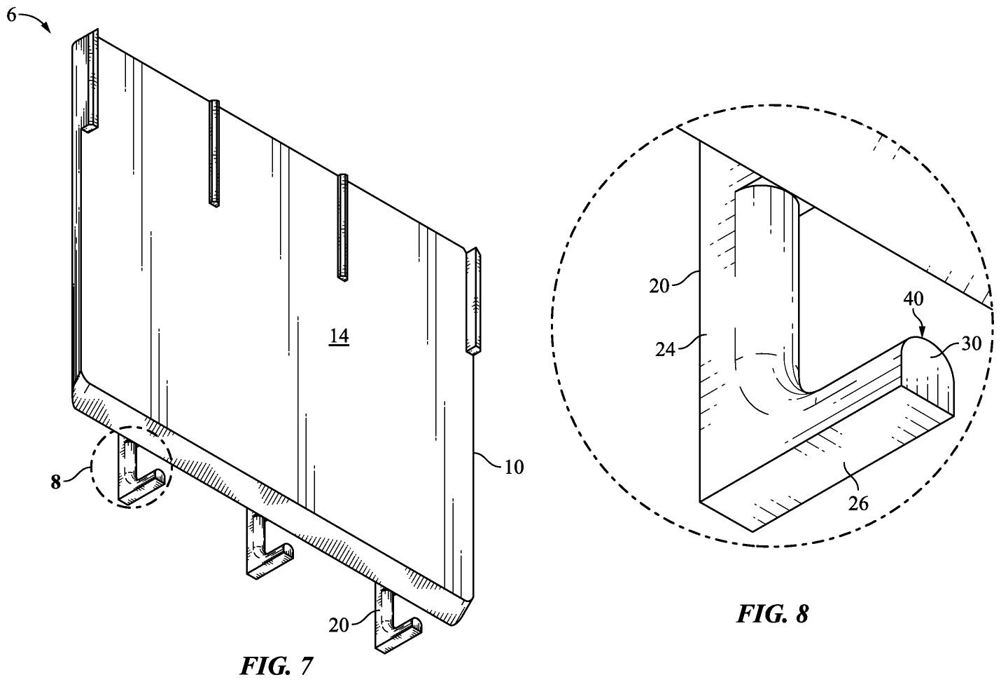

FIG. 7 is a schematic perspective bottom left-hand view of the shelf. FIG. 8 is a schematic perspective detail view of the wicking end support coupled to the support body. The wicking end support 20 with the longitudinal extension 24 is coupled with the upright extension 26 having an end 30. The wicking end support 20 can be formed with a wicking surface 40 generally on the upright extension 26. The wicking surface 40 can be curved as illustrated, but also flat, triangular, or other shapes. The wicking surface 40 forms a contact location for the end of the slide 22 and or other object, shown in FIG. 4, to focus the fluid flow at the end of the slide to a concentrated location.

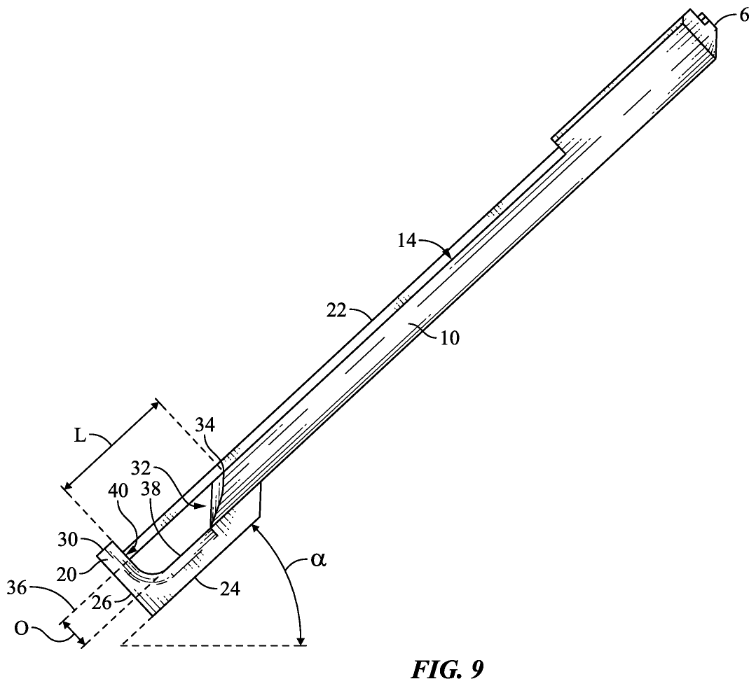

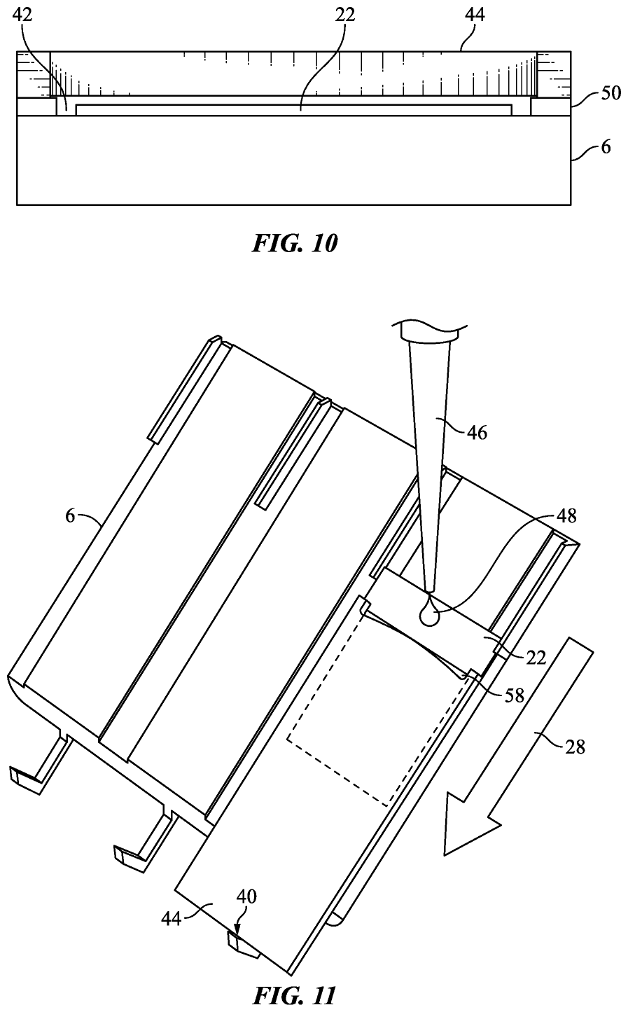

FIG. 9 is a schematic inclined side view of the shelf with an illustrative slide placed on the support surface and supported on an end with the wicking end support. (The cover pad in FIG. 1 is not illustrated in this side view figure to show the slide interaction with the shelf with more clarity.) In more detail, the wicking end support 20 with longitudinal extension 24 and upright extension 26 can be coupled to the bottom end 32 of the shelf body 10. The longitudinal extension 24 can be offset from a plane 36 of the support surface 14 to an offset surface 38 by an offset distance O. The offset can provide enough distance so that fluid as the end of the slide 22 does not drip onto the upright extension 26 and wick upwards along the longitudinal extension 24. It is believed that a distance greater than a diameter of a liquid drop provides sufficient spatial separation. The wicking surface 40 on the upright extension 26 can similarly be spaced distant from an end 34 of the support surface end 34 by a longitudinal distance L. Similarly, it is believed that a distance greater than a diameter of a liquid drop provides sufficient spatial separation.

The angle α of inclination affects the fluid flow velocity and coverage across the slide 22. Adjustments in a number of parameters for different angles may be needed to achieve optimum histological results, including the shape, size, length and height of the wicking end support for applicable fluids applied to the sample and for various types of samples.

FIG. 10 is a schematic top view aligned with the plane of the shelf support surface of a cover pad supported on the shelf with a slide supported by the shelf under the cover pad. The shelf 6 supports the cover pad 44 over a slide 58. To assist in obtaining clearance, the cover pad 44 can include a spacing strip 32 toward each side. The spacing strips 50 can have a thickness sufficient to elevate an object resting on the spacing strip, such as a cover slip 44 or a support tile (not shown. above the support surface to form a space 42 between the object and the support surface. More specifically, the spacing strips can be planar and create (or increase) a space 42 between the cover slip 44 and the shelf 6 on which the slide 22 can be placed. A distance between the underside of the cover slip and the topside of the slide can be sized to help create a capillary effect on fluids between the cover slip and the slide to promote a more uniform spread of fluids across the slide for better preparation of a sample on the slide. The height of the space 42 for optimum performance can be experimentally determined, as would be within the capabilities of a person of ordinary skill in the art.

FIG. 11 is a schematic top right hand perspective view of the cover pad supported on the shelf with a slide supported by the shelf under the cover pad. In operation, a slide 22 with a sample 58 can be placed on the shelf 6, and the cover pad 44 placed over the slide and supported by the shelf with a clearance between the underside of the cover pad and the sample on the top face of the slide, shown in FIG. 10. The slide 22 can extend longitudinally upward toward a top of the shelf 6 farther than the cover pad 44. Fluids 48 can be dispensed by a dispenser 46, such as with a pipette or other device, onto the slide 22 to flow down the inclined surfaces, and spread across the slide 22 and then can at least partially to the wicking surface 40.

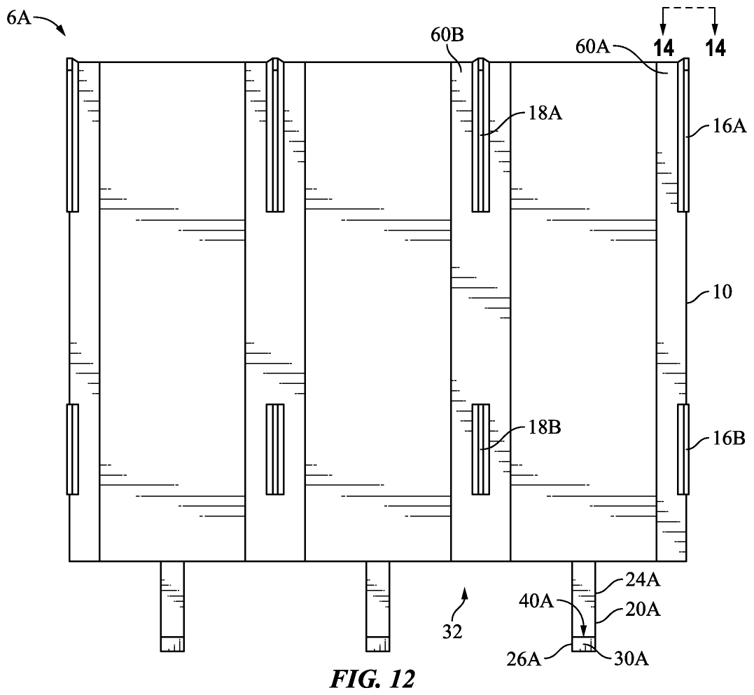

FIG. 12 is a schematic front view of another embodiment of a shelf according to the invention. The shelf 6A is generally constructed similar to the shelf 6 with the body 10 described above. As an illustrative variation, the shelf 6A includes a wicking end support 20A having a longitudinal extension 24A and an upright extension 26A with a flattened wicking surface 40A ending at an end 30A. The flattened wicking surface 40A can have about the same overall width of the upright extension of the wicking end support in FIG. 8 but with a wider contact surface for a bottom of a slide and other object, such as a support tile, supported by the planar support surface of the shelf. As described above, the wicking end support touching the bottom of a slide and other object can assist in drawing fluid from the shelf support surface as the fluid flows to the end of the support surface.

This embodiment also can include longitudinally separated sides rails 16A and 16B on outward surfaces and longitudinally separated guide rails 18A and 18B on inward surfaces of the shelf 6A. The longitudinally separated side and guide rails can be useful with longer shelves that better guide longer slides and support tiles.

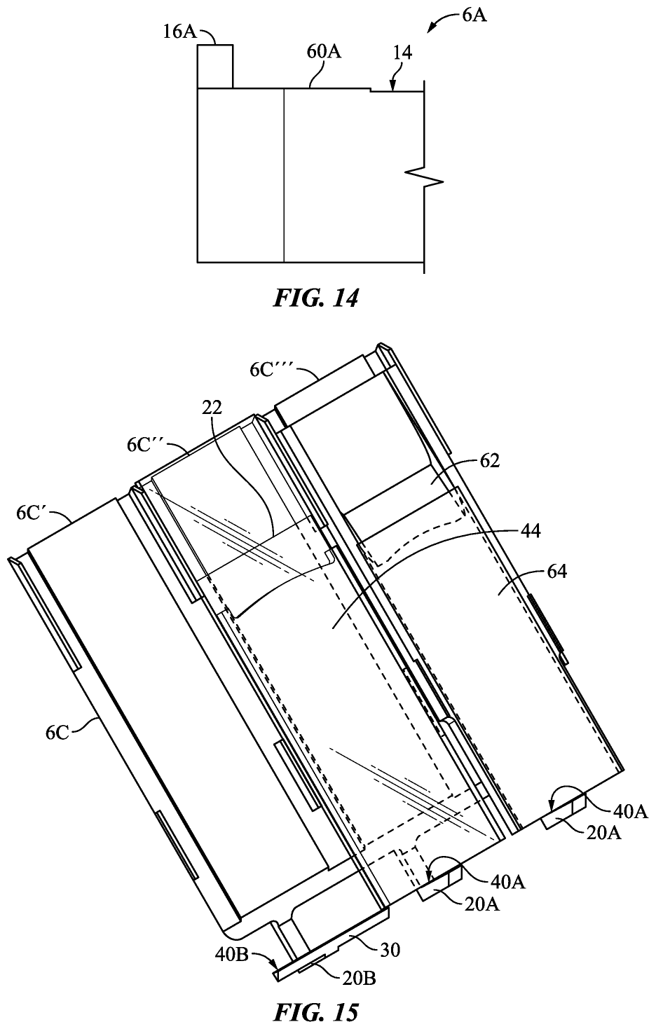

This embodiment further can include a spacing strip 60A on an outward portion of the shelf 6A to support a cover pad or other object over the support surface of the shelf with a gap therebetween to allow fluids to pass over a specimen for processing in a similar manner as described in FIG. 10 with the spacing strip 50. A spacing strip 60B can be positioned inwardly from sides of the shelf and can be double width to support slides and other objects on either side of the guide rails. An illustrative spacing strip is described in more detail in FIG. 14.

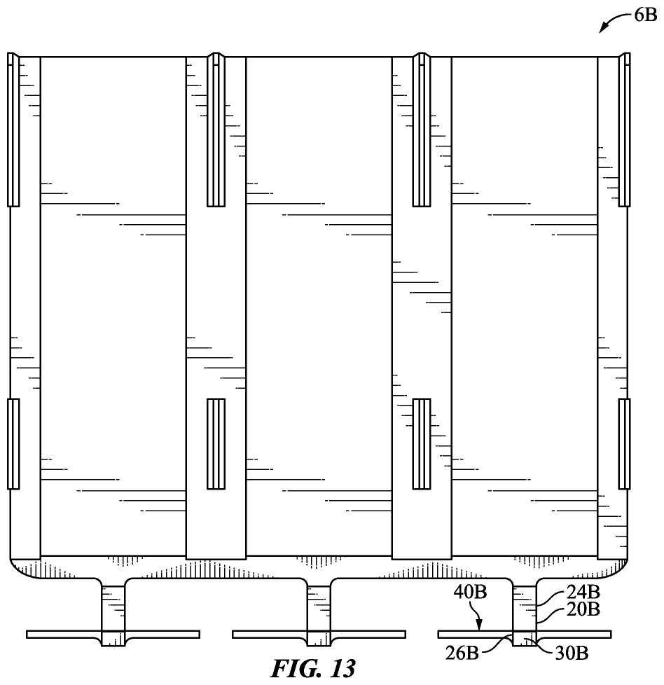

FIG. 13 is a schematic front view of another embodiment of a shelf according to the invention. The shelf 6B is generally constructed similar to the shelves 6 and 6A described above. As an illustrative variation, the shelf 6B includes a wicking end support 20B having a longitudinal extension 24B and an upright extension 26B with a flattened wicking surface 40B ending at an end 30B. The flattened wicking surface 40B can have about the greater width than the wicking end supports 20 and 20A in the above Figures such as a width of a histological sample on a slide or support tile or width of the slide or support tile. The wider wicking end support may provide more uniformity of wicking across the lateral surface of the slide or support tile to wick more evenly.

FIG. 14 is a schematic detail view of a portion of a shelf. One or more of the spacing strips 60A and 60B can extend, for example, a full length of the shelf or an object supported by the shelf. The spacing strips 60A and 60B can be coupled to the shelf 6, integrally or as one or more separate components. The spacing strips 60A and 60B can be made of a silicone or like substance to form a seal between the cover slip and the shelf, although other materials including metals and composites can be used.

FIG. 15 is a schematic perspective top left-hand view of another embodiment of a shelf according to the invention to support histological samples. The shelf 6C illustrates a combination of shelves described above. For example, a shelf section 6C′ can be constructed as described in FIG. 13 with a wicking end support 20B having a relatively wide wicking surface 40B. Shelf sections 6C″ and 6C″′ can be constructed as described in FIG. 12 with a wicking end support 20A having a relatively narrow wicking surface 40A.

FIG. 15 also illustrates that different shelf sections can support different objects for histological processing of samples. For example, a slide 22 with a specimen can be placed in the illustrated 6C″ shelf section and a cover pad 44 placed over the specimen, generally with a gap between the specimen and the cover pad to allow fluids to pass in the gap for histological processing and flow down to the wicking surface 40A. For further example, a support tile 62 can be placed in the shelf section 6C″′ with a specimen mounted to an underside of a planar support 64, such as a cover slip. The cover slip and specimen can be placed over the support tile generally with a gap between the specimen and the cover slip to allow fluids to pass in the gap for histological processing and flow down to the wicking surface 40A.

Other and further embodiments utilizing one or more aspects of the inventions described above can be devised without departing from the disclosed invention as defined in the claims.

For example, other embodiments can include different alignments in the container for the shelves, the number of slides that can be supported by a shelf, placement of side rails and guide rails, angle of inclination, size, length and height of the wicking end support, various cross sectional shapes of the wicking surface, and other variations than those specifically disclosed herein within the scope of the claims.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intend to protect fully all such modifications and improvements that come within the scope of the following claims.

What is claimed is:

1. A histological containment system having a container for preparing histological samples, comprising:
a shelf configured to fit the container, comprising:
a support body having a support surface configured to support a histological sample; and
a wicking end support coupled to the support body, comprising
a longitudinal extension that extends longitudinally from an end of the support surface; and
an upright extension coupled to the longitudinal extension that extends transverse at a nonzero angle to a plane of the support surface;
wherein the longitudinal extension is coupled to the support body with the wicking end support offset by a non-zero offset distance from the plane of the support surface vertically; and
wherein the upright extension is coupled to the longitudinal extension by non-zero longitudinal distance from an end of the support body to a proximal surface of the upright extension.

2. The histological containment system of claim 1, wherein the offset distance is larger than a diameter of a water droplet.

3. The histological containment system of claim 1, wherein the longitudinal distance is larger than a diameter of a water droplet.

4. The histological containment system of claim of claim 1, wherein the support surface is configured to support the histological sample at an inclined angle to a horizontal line.

5. The histological containment system of claim 4, wherein the wicking end support comprises a wicking surface configured to receive fluid flowing down the shelf by the inclined angle.

6. The histological containment system of claim 4, wherein the wicking surface is formed of one of a curved shape and a flat shape.

7. The histological containment system of claim 4, wherein the wicking surface is at least as wide as the histological sample width.

8. The histological containment system of claim 1, further comprising a spacing strip coupled to the support surface having a thickness to elevate an object resting on the spacing strip above the support surface to form a gap between the object and the support surface.

9. The histological containment system of claim 1, wherein the shelf is configured to support a plurality of histological samples across the support surface.

10. The histological containment system of claim of claim 1, wherein the support surface of the shelf is divided into shelf sections by at least one guard rail.

11. The histological containment system of claim 1, further comprising the container, wherein the container comprises a container support configured to support the shelf.
